(19) United States
(12) Patent Application Publication
(10) Pub. No.: US 2019/0144041 A1
(43) Pub. Date: May 16, 2019

(54) SYSTEM OF A REINFORCED STRUCTURAL ELEMENT

(71) Applicant: SIKA TECHNOLOGY AG, Baar (CH)

(72) Inventors: Vincent BELPAIRE, Uccle (BE); Ardi SHEHU, Rotselaar (BE)

(73) Assignee: SIKA TECHNOLOGY AG, Baar (CH)

(21) Appl. No.: 16/191,861

(22) Filed: Nov. 15, 2018

(30) Foreign Application Priority Data
Nov. 15, 2017 (EP) 17201951.5

(51) Int. Cl. B62D 25/02; B62D 25/04; B62D 27/02; B62D 29/04; B62D 29/00; B32B 7/12; B32B 27/08

(52) U.S. Cl. CPC B62D 25/025; B62D 25/04; B62D 27/026; B32B 2605/003; B62D 29/008; B32B 7/12; B32B 27/08; B62D 29/04

(57) ABSTRACT

A system of a reinforced structural element of a motor vehicle includes a structural element, a reinforcing element, and an adhesive. The structural element has a first panel sheet and a second panel sheet which form in each case three regions between two joints. The reinforcing element is adhesively bonded to two pairs of mutually opposite regions of the panel sheets.

The present invention relates to a system of a reinforced structural element of a motor vehicle.

Construction elements such as, for example, bodies and/or chassis frames of transportation and conveyance means, in particular of aquatic or terrestrial vehicles or of aircraft, in many instances have structures having cavities in order for lightweight constructions to be enabled. These cavities however cause the most varied of problems. Depending on the type of the cavity, the latter has to be sealed in order to prevent the ingress of moisture and contaminations which can lead to corrosion of the construction elements. It is often also desirable for the cavities and thus the construction element to be substantially reinforced but for the low weight to be maintained. It is often also necessary for the cavities and thus the construction elements to be stabilized in order for noises which would otherwise be transmitted along the cavity or through the latter to be reduced. Many of these cavities have an irregular shape or tight dimensions, on account of which it becomes difficult to properly seal, reinforce, and insulate said cavities.

Sealing elements (baffles) are therefore used in particular in the automotive industry but also in the aviation and nautical industry in order for cavities to be sealed and/or to be acoustically closed off, or reinforcing elements (reinforcers) are used in order for cavities to be reinforced.

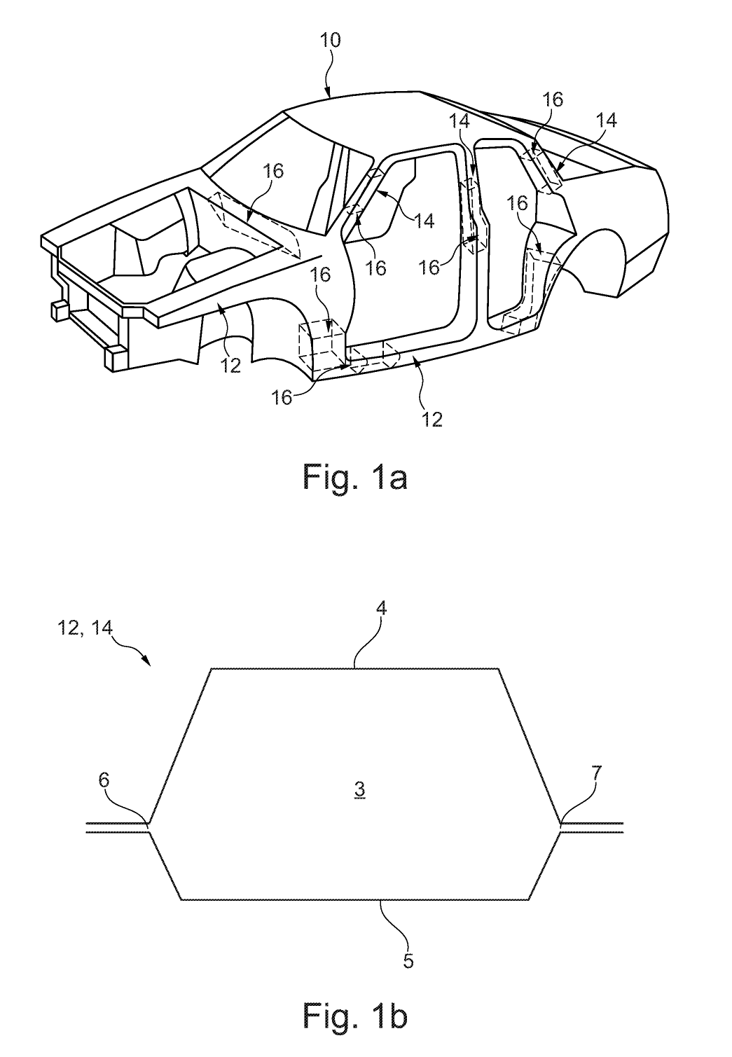

A body of an automobile is schematically illustrated in FIG. 1a. The body 10 herein has various structures having cavities such as, for example, pillars 14 and supports or stays 12, respectively. Such structural elements 12, 14 having cavities are usually sealed or reinforced, respectively, using sealing and/or reinforcing elements 16.

A cross section through a structural element 12, 14 is schematically illustrated in FIG. 1b. As is often the case in such structural elements 12, 14, a first panel sheet 4 and a second panel sheet 5 are joined together at joints 6, 7, wherein the panel sheets 4, 5 configure a cavity 3 between the joints 6, 7.

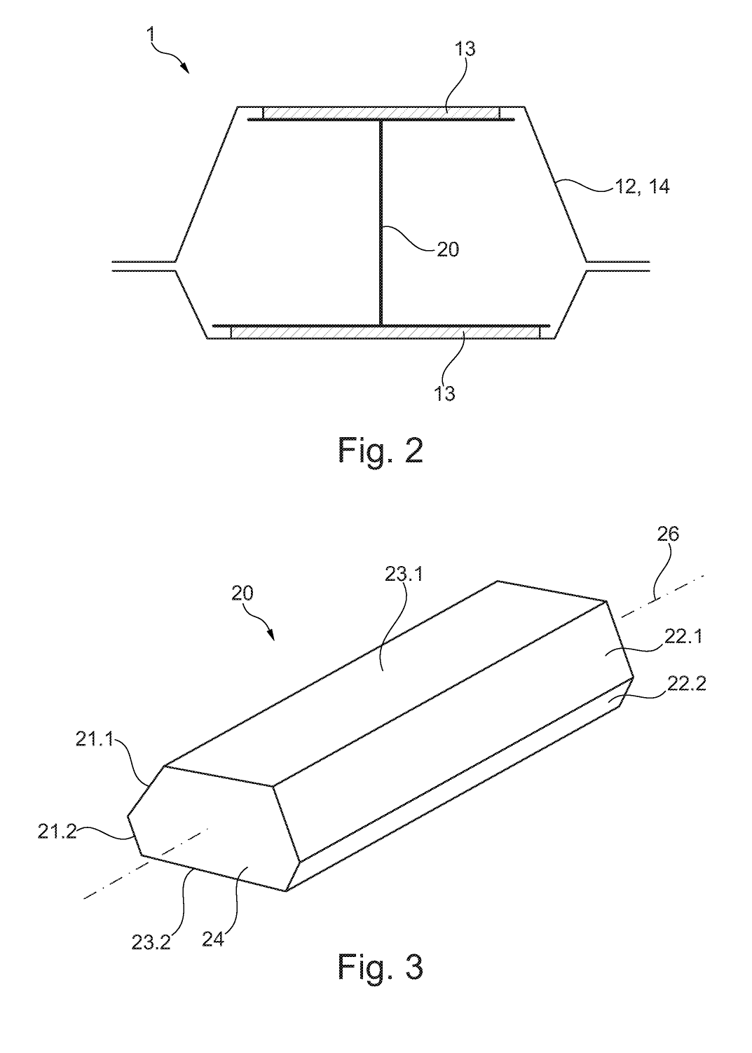

A known system 1 of a reinforced structural element 12, 14 is illustrated in FIG. 2. A reinforcing element 20 herein is disposed in the cavity of the structural element 12, 14 and is adhesively bonded to the structural element 12, 14 by way of adhesive 13. The reinforcing element 20 has two mutually opposite mating faces which are in each case mated to a panel sheet of the structural element 12, 14. In such known solutions it is disadvantageous that the structural element 12, 14, on account of the limited mating face of the reinforcing element 20 for mating to the structural element 12, 14, cannot be reinforced in an ideal manner.

It is therefore an object of the present invention to provide an improved system of a reinforced structural element which has a higher mechanical load-bearing capability. An improved mating between the reinforcing element and the structural element is to be achieved in particular.

This object is achieved by a system of a reinforced structural element of a motor vehicle, wherein the system comprises: a structural element which comprises a first panel sheet and a second panel sheet, wherein the panel sheets are connected to one another at a first joint and at a second joint, and wherein the panel sheets form an elongate cavity in the region between the first joint and the second joint, and wherein the panel sheets between the joints form in each case one first region, one second region, and one third region; a reinforcing element which comprises a first side wall, a second side wall, and a connecting wall connecting the side walls, and which is disposed in the cavity of the structural element; and adhesive which adhesively bonds the reinforcing element to the structural element; wherein the reinforcing element is adhesively bonded to a first pair of mutually opposite regions of the panel sheets, and to a second pair of mutually opposite regions of the panel sheets.

This solution offers the advantage that, on account thereof, a mating face of the reinforcing element for the adhesive bonding to the structural element is increased. Moreover, additional regions of the structural element can be adhesively bonded to the reinforcing element on account thereof. All the aforegoing contributes towards a higher mechanical load-bearing capability of the reinforced structural element.

It is a core concept of the present invention that the reinforcing element is to be adhesively bonded to the structural element by way of a largest possible face, and that in particular various regions of the structural element are to be adhesively bonded to the reinforcing element in order for a higher mechanical load-bearing capability of the reinforced structural element to be obtained. It has been demonstrated that an adhesive bonding of the reinforcing element to the structural element in particular in the regions of the joints has a positive effect on the mechanical load-bearing capability of the entire system.

In one exemplary embodiment the first regions of the panel sheets are disposed at the first joint, the third regions of the panel sheets are disposed at the second joint, and the second regions of the panel sheets are disposed between the first regions and the third regions.

Individual regions herein can mutually transition in a smooth manner or else be mutually separated by bent features in the panel sheets. It is also possible for regions of the panel sheets that lie beside one another to lie in one and the same plane.

The individual regions can be of approximately identical dimensions, for example, or else individual regions can be designed so as to be larger or smaller than other regions.

In one exemplary embodiment the first region of the first panel sheet conjointly with the third region of the second panel sheet forms a pair of mutually opposite regions, and the second region of the first panel sheet conjointly with the second region of the second panel sheet forms a pair of mutually opposite regions, and the third region of the first panel sheet conjointly with the first region of the second panel sheet forms a pair of mutually opposite regions.

In one exemplary embodiment the first side wall comprises a first part-wall and a second part-wall, and the second side wall comprises a first part-wall and a second part-wall, wherein the first part-wall and the second part-wall of one side wall are in each case disposed substantially in different planes.

In one exemplary refinement the first side wall on one of the part-walls is adhesively bonded to the first panel sheet and on one of the part-walls is adhesively bonded to the second panel sheet, wherein the second side wall on one of the part-walls is adhesively bonded to the first panel sheet and on one of the part-walls is adhesively bonded to the second panel sheet.

The provision of such part-walls has the advantage that, on account thereof, the reinforcing element can be better adapted to the shape of the structural element such that a largest possible mating face of the reinforcing element is available for the adhesive bonding to the structural element.

In one exemplary embodiment the connecting wall interconnects the first side wall and the second side wall in such a manner that the connecting wall is disposed so as to be substantially diagonal in the structural element.

In one alternative embodiment the connecting wall comprises a first part-wall and a second part-wall, wherein the first part-wall and the second part-wall interconnect in each case the first side wall and the second side wall.

In one exemplary embodiment the first side wall on one of the part-walls is adhesively bonded to the first panel sheet or on one of the part-walls is adhesively bonded to the second panel sheet, and the second side wall on one of the part-walls is adhesively bonded to the first panel sheet or on one of the part-walls is adhesively bonded to the second panel sheet, and the first part-wall of the connecting wall is adhesively bonded to the first panel sheet, and the second part-wall of the connecting wall is adhesively bonded to the second panel sheet.

This has the advantage that an entire mating face can be enlarged on account of the use of the connecting wall as an additional mating face of the reinforcing element for the adhesive bonding to the structural element.

In one exemplary embodiment the reinforcing element is adhesively bonded to a third pair of mutually opposite regions of the panel sheets.

This has the advantage that, on account thereof, a mating face of the reinforcing element for the adhesive bonding to the structural element is again enlarged.

In one exemplary embodiment, the reinforcing element is at least partially constructed from fibre-reinforced plastic or from plastic or from aluminium or from magnesium.

In one exemplary embodiment all walls of the reinforcing element are formed from the same material.

In one exemplary embodiment the adhesive has an expansion rate of less than 500%, or less than 400%, or less than 300%, or the adhesive is a non-expandable adhesive.

Materials which are expandable to a lesser degree, or non-expandable materials, offer the advantage that the adhesive, on account thereof, does not lose mechanical stability to an excessive degree. In principle, a material becomes weaker in mechanical terms the more the material is expanded.

SikaReinforcer®-940 or SikaPower®-497 are examples of adhesives which are non-expandable or expandable to a lesser degree. SikaReinforcer®-940 herein is an example of an expandable material, whereas SikaPower®-497 is an example of a non-expandable material.

The term “non-expandable” in the context of this invention means that a material varies the volume thereof by not more than or less than 10% in the process steps envisaged for said material. For example, non-expandable adhesive can shrink to a minor degree when curing. Such a volumetric variation when curing is considered to be “non-expandable” in the context of this application.

In one exemplary embodiment the adhesive is curable at a temperature of more than 120°.

In one further alternative embodiment the system comprises a first adhesive and a second adhesive, wherein the adhesives have dissimilar properties, in particular in terms of expansion and/or curing and/or a mating capability and/or mechanical loading.

In one exemplary embodiment, the adhesive is a tape adhesive, a shape memory adhesive, an injectable adhesive, an injection-moulded adhesive or an extruded adhesive.

In one exemplary embodiment, the adhesive has a layer thickness of 0.3 to 7 mm, or of 1 to 6 mm, or of 2 to 5 mm.

In one exemplary embodiment, the reinforcing element comprises ribs which are oriented so as to be substantially orthogonal to a longitudinal axis of the reinforcing element, and which interconnect the first side wall and the second side wall.

The provision of such ribs offers the advantage that, on account thereof, a mechanical load-bearing capability of the reinforcing element can be further increased.

In one exemplary embodiment the first side wall in the region of the first joint is adhesively bonded to the first panel sheet and to the second panel sheet by way of a continuous layer of adhesive.

In one exemplary embodiment the second side wall in the region of the second joint is adhesively bonded to the first panel sheet and to the second panel sheet by way of a continuous layer of adhesive.

The adhesive bonding of the reinforcing element to the structural element in the region of the joints by way of a continuous layer of adhesive offers the advantage that, on account thereof, a mechanical load-bearing capability of the entire system can be further increased.

The reinforcing element described here can be produced by a three-dimensional printing method, for example.

Details and advantages of the invention will be described hereunder by means of exemplary embodiments and with reference to schematic drawings.

In the drawings:

FIG. 1a shows a schematic illustration of a body;

FIG. 1b shows a schematic illustration of a cross section through a structural element;

FIG. 2 shows a schematic illustration of a system of a reinforced structural element according to the prior art;

FIG. 3 shows a schematic illustration of a reinforcing element; and

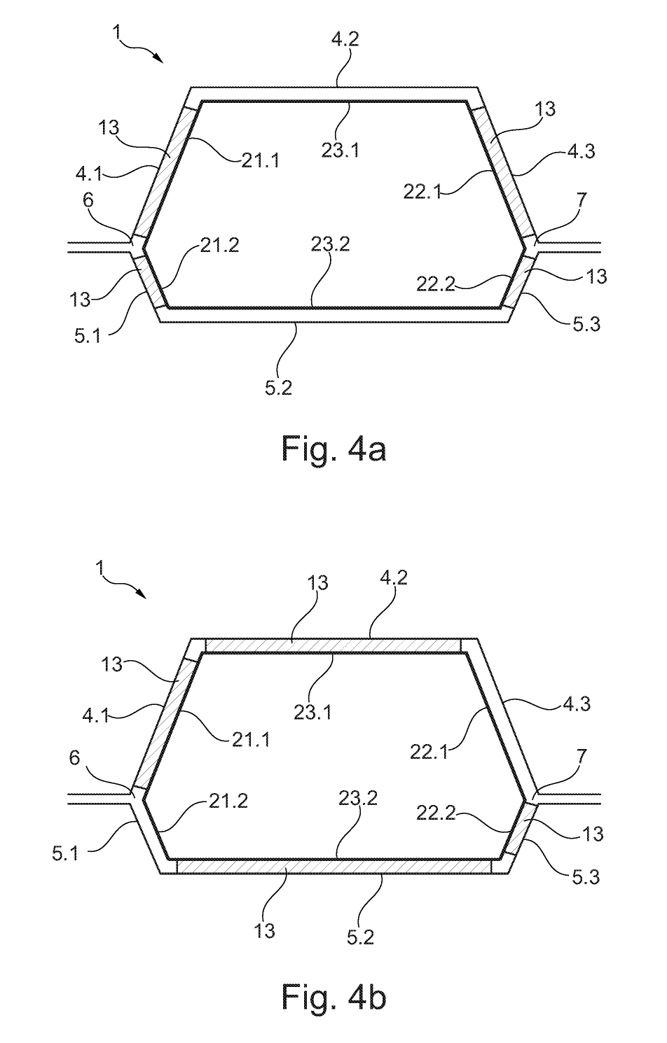

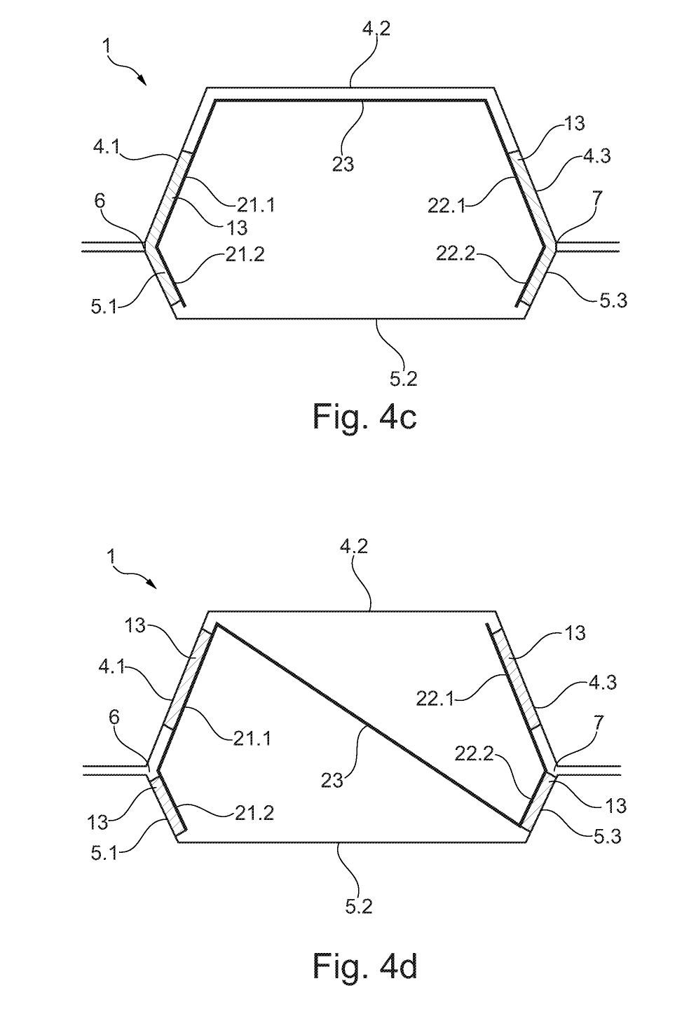

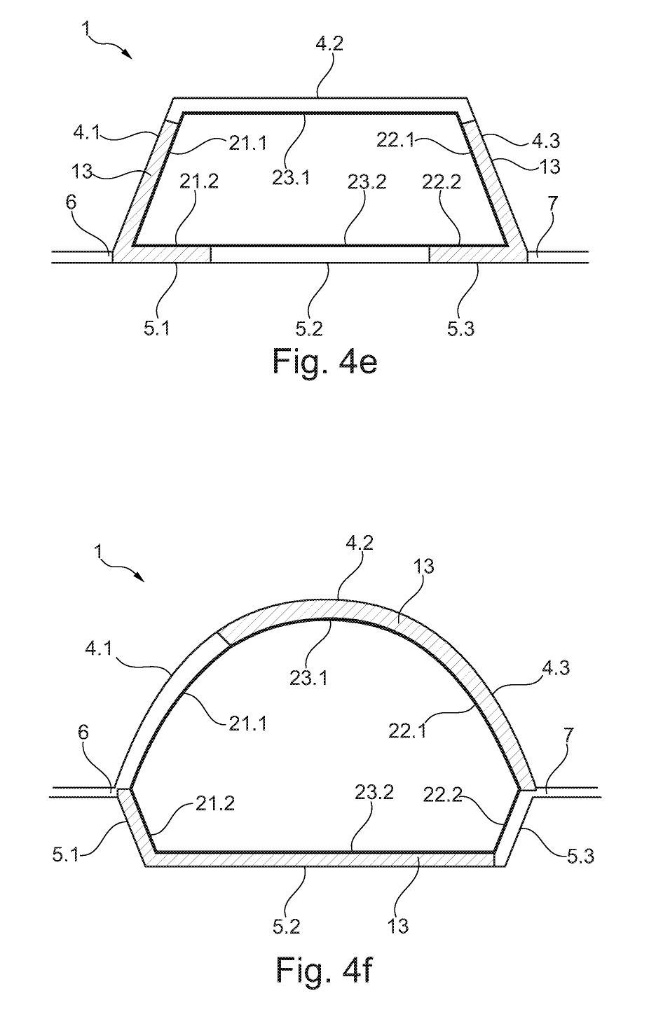

FIGS. 4a to 4f show a schematic illustration of a system of a reinforced structural element.

An exemplary reinforcing element 20 is illustrated in FIG. 3. The reinforcing element 20 has a longitudinal axis 26. Side walls 21, 22 and the connecting wall 23 herein extend in the direction of said longitudinal axis 26. In this exemplary embodiment both the side walls 21, 22 as well as the connecting wall 23 have in each case one first part-wall 21.1, 22.1, 23.1, and one second part-wall 21.2, 22, 2, 23.2. The connecting walls 23.1, 23.2 herein interconnect in each case the side walls 21, 22.

The exemplary reinforcing element 20 illustrated here furthermore has a front and rear wall 24.

It can be seen from this spatial illustration according to FIG. 3 that the reinforcing element 20 has a large mating face for the adhesive bonding to the structural element.

Various exemplary embodiments of systems 1 of reinforced structural elements 12, 14 are illustrated in the cross section in FIGS. 4a to 4f.

In each of these exemplary embodiments, at least two pairs of mutually opposite regions 4.1, 4.2, 4.3, 5.1, 5.2, 5.3 of the panel sheets 4, 5 are adhesively bonded to the reinforcing element 20, using adhesive 13.

The reinforcing element 20 in FIG. 4a has in each case side walls 21, 22 and one connecting wall 23, said walls being subdivided into part-walls. In this exemplary embodiment, the first region 4.1 of the first panel sheet 4 and the third region 5.3 of the second panel sheet 5 form a first pair of mutually opposite regions, said pair by means of adhesive 13 being adhesively bonded to the reinforcing element. Furthermore, the first region 5.1 of the second panel sheet 5 and the third region 4.3 of the first panel sheet 4 form a second pair of mutually opposite regions, said pair by means of adhesive 13 likewise being adhesively bonded to the reinforcing element 20. The part-walls 23.1, 23.2 of the connecting wall 23 in this exemplary embodiment are not adhesively bonded to the structural element 12, 14.

The adhesive 13 in this exemplary embodiment does not form any continuous layer in the region of the joints 6, 7.

A further example of a system 1 of a reinforced structural element 12, 14 is illustrated in FIG. 4b. By contrast to the exemplary embodiment according to FIG. 4a, other regions of the panel sheets 4, 5 here are adhesively bonded to the reinforcing element 20. However, two pairs of mutually opposite regions 4.1, 4.2, 5.2, 5.3 of the panel sheets 4, 5 are again adhesively bonded to the reinforcing element 20.

A further exemplary embodiment of a system 1 of a reinforced structural element 12, 14 is illustrated in FIG. 4c. By contrast to the exemplary embodiment according to FIG. 4a, the connecting wall 23 here is not subdivided into part-walls. Moreover, the adhesive 13 here is in each case disposed in a continuous layer in the region of the joints 6, 7 such that the side walls 21, 22 in said regions are adhesively bonded to the panel sheets 4, 5 in a continuous manner.

A further exemplary embodiment of a system 1 of a reinforced structural element 12, 14 is illustrated in FIG. 4d. By contrast to the exemplary embodiment according to FIG. 4a, the connecting wall 23 here is configured such that said connecting wall comes to lie so as to be substantially diagonal in the structural element 12, 14. Two pairs of mutually opposite regions 4.1, 4.3, 5.1, 5.3 of the panel sheets 4, 5 by means of adhesive 13 are again adhesively bonded to the reinforcing element 20.

A further exemplary embodiment of a system 1 of a reinforced structural element 12, 14 is illustrated in FIG. 4e. The regions 5.1, 5.2, 5.3 of the second panel sheet 5 in this exemplary embodiment are configured so as to be continuous, wherein the regions 5.1, 5.2, 5.3 lie in a common plane. The first region 5.1 herein is disposed at the first joint 6, the third region 5.3 is disposed at the second joint 7, and the second region 5.2 is disposed between the first region 5.1 and the third region 5.3. However, the regions 4.1, 4.2, 4.3 of the first panel sheet 4 are configured so as to be mutually separated by bent features in the panel sheet 4. Two pairs of mutually opposite regions 4.1, 4.3, 5.1, 5.3 of the panel sheets 4, 5 by means of adhesive 13 are again adhesively bonded to the reinforcing element 20. In this exemplary embodiment a continuous adhesive layer 13 is provided in the region of the joints 6, 7.

A further exemplary embodiment of a system 1 of a reinforced structural element 12, 14 is illustrated in FIG. 4f. The regions 4.1, 4.2, 4.3 of the first panel sheet 4 in this exemplary embodiment are configured so as to be continuous. The first panel sheet 4 herein forms an arcuate cross section, and the regions 4.1, 4.2, 4.3 are composed of portions of said arcuate cross section of the first panel sheet 4. The first region 4.1 herein is disposed at the first joint 6, the third region 4.3 is disposed at the second joint 7, and the second region 4.2 is disposed between the first region 4.1 and the third region 4.3.

Two pairs of mutually opposite regions 4.2, 4.3, 5.1, 5.2 of the panel sheets 4, 5 by means of adhesive 13 are again adhesively bonded to the reinforcing element 20.

### LIST OF REFERENCE SIGNS

1 System

3 Cavity

4 First panel sheet

4.1 First region of the first panel sheet

4.2 Second region of the first panel sheet

4.3 Third region of the first panel sheet

5 Second panel sheet

5.1 First region of the second panel sheet

5.2 Second region of the second panel sheet

5.3 Third region of the second panel sheet

6 First joint

7 Second joint

10 Body

12 Structural element

13 Adhesive

14 Structural element

16 Sealing and/or reinforcing element

20 Reinforcing element

21 First side wall

21.1 First part-wall of the first side wall

21.2 Second part-wall of the first side wall

22 Second side wall

22.1 First part-wall of the second side wall

22.2 Second part-wall of the second side wall

23 Connecting wall

23.1 First part-wall of the connecting wall

23.2 Second part-wall of the connecting wall

24 Front/rear wall

26 Longitudinal axis

1. A system of a reinforced structural element of a motor vehicle, the system comprising:
a structural element which comprises a first panel sheet and a second panel sheet, wherein the panel sheets are connected to one another at a first joint and at a second joint, and wherein the panel sheets form an elongate cavity in the region between the first joint and the second joint, and wherein the panel sheets between the joints form in each case one first region, one second region, and one third region;
a reinforcing element which comprises a first side wall, a second side wall, and a connecting wall connecting the side walls, and which is disposed in the cavity of the structural element; and
an adhesive which adhesively bonds the reinforcing element to the structural element;
wherein the reinforcing element is adhesively bonded to a first pair of mutually opposite regions of the panel sheets, and to a second pair of mutually opposite regions of the panel sheets.

2. The system according to claim 1, wherein the first region of the first panel sheet conjointly with the third region of the second panel sheet forms a pair of mutually opposite regions, and wherein the second region of the first panel sheet conjointly with the second region of the second panel sheet forms a pair of mutually opposite regions, and wherein the third region of the first panel sheet conjointly with the first region of the second panel sheet forms a pair of mutually opposite regions.

3. The system according to claim 2, wherein the first side wall comprises a first part-wall and a second part-wall and wherein the second side wall comprises a first part-wall and a second part-wall, wherein the first part-wall and the second part-wall of one side wall are in each case disposed substantially in different planes.

4. The system according to claim 3, wherein a first side wall on one of the part-walls is adhesively bonded to the first panel sheet and on one of the part-walls is adhesively bonded to the second panel sheet, and wherein the second side wall on one of the part-walls is adhesively bonded to the first panel sheet and on one of the part-walls is adhesively bonded to the second panel sheet.

5. The system according claim 1, wherein the connecting wall interconnects the first side wall and the second side wall in such a manner that the connecting wall is disposed so as to be substantially diagonal in the structural element.

6. The system according to claim 1, wherein the connecting wall comprises a first part-wall and a second part-wall, wherein the first part-wall and the second part-wall interconnect in each case the first side wall and the second side wall.

7. The system according to claim 6, wherein a first side wall on one of the part-walls is adhesively bonded to the first panel sheet or on one of the part-walls is adhesively bonded to the second panel sheet, and wherein the second side wall on one of the part-walls is adhesively bonded to the first panel sheet or on one of the part-walls is adhesively bonded to the second panel sheet, and wherein the first part-wall of the connecting wall is adhesively bonded to the first panel sheet, and wherein the second part-wall of the connecting wall is adhesively bonded to the second panel sheet.

8. The system according to claim 6, wherein the reinforcing element is adhesively bonded to a third pair of mutually opposite regions of the panel sheets.

9. The system according to claim 1, wherein the reinforcing element is at least partially constructed from fibre-reinforced plastic or from plastic or from aluminium or from magnesium.

10. The system according to claim 1, wherein all walls of the reinforcing element are formed from the same material.

11. The system according to claim 1, wherein the adhesive is a non-expandable adhesive or an adhesive having an expansion rate of less than 500%.

12. The system according to claim 1, wherein the adhesive is a tape adhesive, a shape memory adhesive, an injectable adhesive, an injection-moulded adhesive or an extruded adhesive.

13. The system according to claim 1, wherein the adhesive has a layer thickness of 0.3 to 7 mm.

14. The system according to claim 1, wherein the reinforcing element comprises ribs which are oriented so as to be substantially orthogonal to a longitudinal axis of the reinforcing element, and which interconnect the first side wall and the second side wall.

15. The system according to claim 1, wherein the first side wall in the region of the first joint is adhesively bonded to the first panel sheet and to the second panel sheet by way of a continuous layer of adhesive, and/or
wherein the second side wall in the region of the second joint is adhesively bonded to the first panel sheet and to the second panel sheet by way of a continuous layer of adhesive.
